(19) United States
(12) Patent Application Publication
(10) Pub. No.: US 2017/0256967 A1
(43) Pub. Date: Sep. 7, 2017

(54) POWER BANK WITH A SINGLE PORT FOR CHARGE AND DISCHARGE

(71) Applicant: FOXCONN INTERCONNECT TECHNOLOGY LIMITED, Grand Cayman (KY)

(72) Inventor: ZHI-QIANG WANG, Kunshan (CN)

(21) Appl. No.: 15/447,605

(22) Filed: Mar. 2, 2017

(30) Foreign Application Priority Data
Mar. 2, 2016 (CN) 201620157759.5

(51) Int. Cl. H02J 7/00

(52) U.S. Cl. CPC H02J 7/0042; H02J 7/0052; H02J 7/0063

(57) ABSTRACT

A power bank comprises a storage unit, a control printed circuit board defining an electrical connector having a plug interface exposed to the power bank for charging and discharging, a connecting module electrically connected between the storage unit and the control printed circuit board and an outer case having a first containment cavity and a second containment cavity to contain the storage unit and the control printed circuit board, respectively, wherein the connecting module includes a spacer plate separating the first containment cavity from the second containment cavity and a plurality of metal pieces, the spacer plate has a slit for allowing each of the metal pieces to pass through, and two opposite ends of each metal piece are electrically connected to the storage unit and the control printed circuit board, respectively.

### BACKGROUND OF THE INVENTION

1. Field of the Invention

The present invention relates generally to power bank and more particularly to a power bank with a single port for charge and discharge.

2. Description of Related Arts

Existing power bank usually has a charging port and a discharging port. In use, the charging port is for power bank charging, while the discharging port is for charging mobile devices. The charging port and the discharging port, for purpose of distinction, usually use different types of connectors, which is inconvenient and may even cause damage to the ports.

China Patent No. 202817803, issued on Mar. 20, 2013, discloses a power band circuit design having a signal port for charging and discharging. The power bank includes a master MCU, which is connected to an electronic device insertion sampling identification circuit, an electronic device discharge execution switch, an internal charge identification circuit, an internal charge execution switch, an internal charge management Circuit, and an LED. The electronic device insertion sampling identification circuit is connected to a USB interface. The discharge switch for electronic device is connected to a booster circuit and is connected to the USB interface via the boost circuit. The internal charging identification circuit is connected to the USB interface and is connected to the internal charging executing switch indirectly. The internal charging operation switch is connected to the internal charging management circuit, and the internal charging management circuit is connected to an internal battery.

### SUMMARY OF THE INVENTION

An object of the present invention is to provide an improved power bank with a single port for charge and discharge.

To achieve the above-mentioned object, a power bank comprises: a storage unit, a control printed circuit board defining an electrical connector having a plug interface exposed to the power bank for charging and discharging, a connecting module electrically connected between the storage unit and the control printed circuit board and an outer case having a first containment cavity and a second containment cavity to contain the storage unit and the control printed circuit board, respectively, wherein the connecting module includes a spacer plate separating the first containment cavity from the second containment cavity and a plurality of metal pieces, the spacer plate has a slit for allowing each of the metal pieces to pass through, and two opposite ends of each metal piece are electrically connected to the storage unit and the control printed circuit board, respectively.

### BRIEF DESCRIPTION OF THE DRAWING

FIG. 1 is a perspective view of a power bank in accordance with the present invention;

FIG. 2 is a perspective view of the power bank in FIG. 1, but from a different aspect;

FIG. 3 and FIG. 4 are exploded views of the power bank in FIG. 1;

FIG. 5 is a perspective view of the power bank in FIG. 3, remove the outer case; and

FIG. 6 is a perspective view of the power bank in FIG. 3, but from a different aspect.

### DETAILED DESCRIPTION OF THE PREFERRED EMBODIMENT

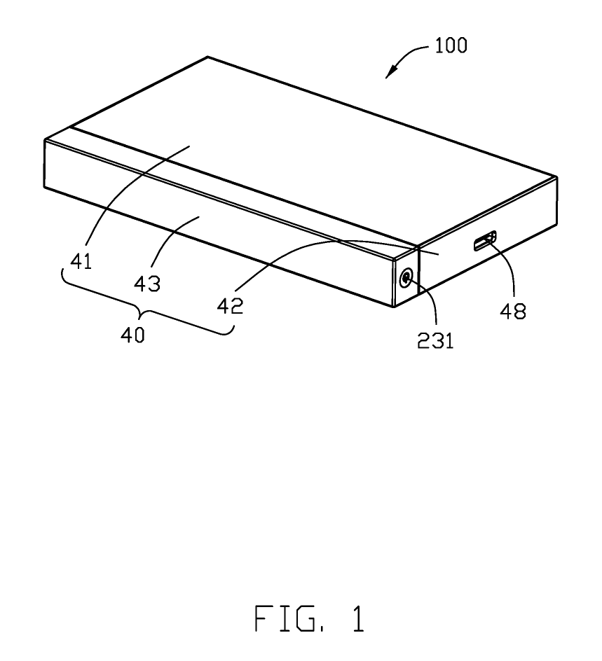

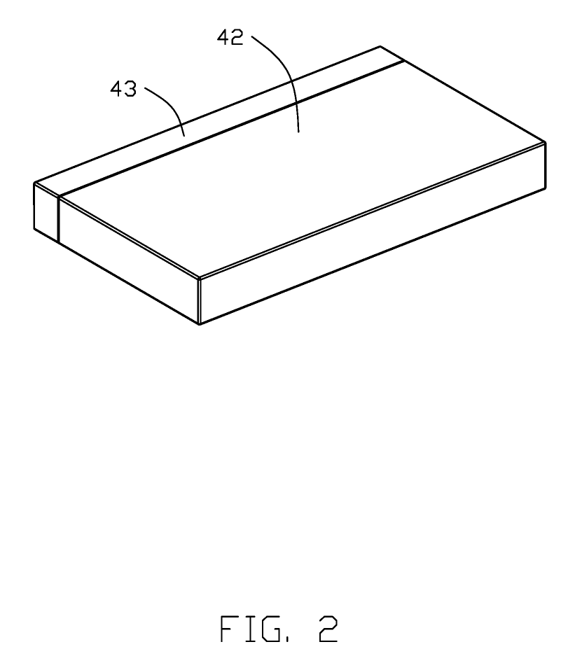

Referring to FIGS. 1 to 4, a power bank 100 as shown is used to provide a power supply for a mobile device. The power bank 100 includes a pair of storage units 10 stacked in a vertical direction, a control printed circuit board 20 electrically connecting with the pair of storage units 10, a connecting module 30 electrically connected between the storage units 10 and the control printed circuit board 20, and an outer case 40 enclosing the storage units 10 and the control printed circuit board 20.

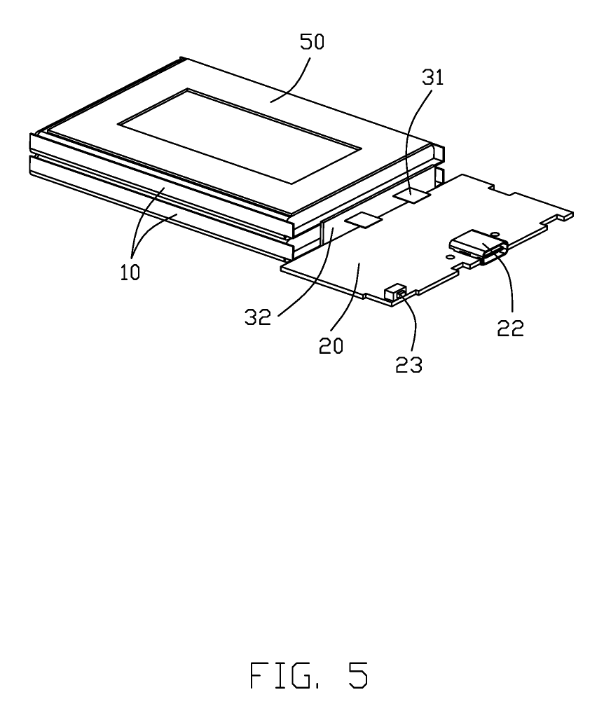

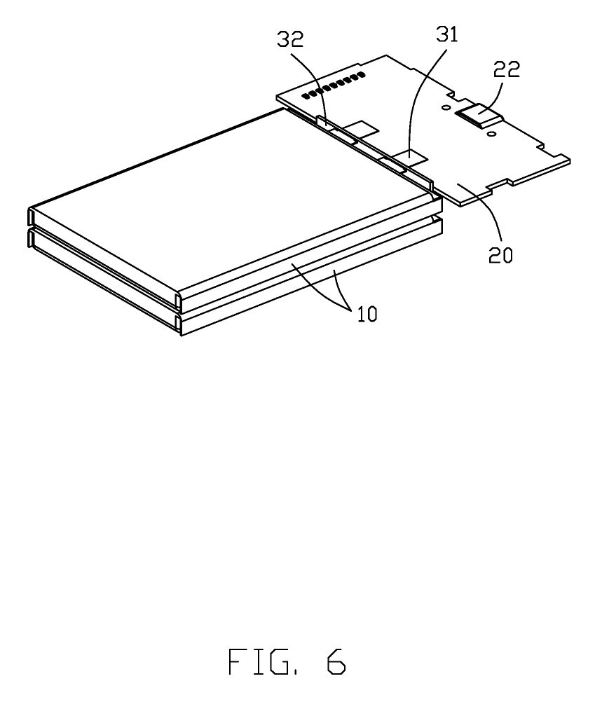

Referring to FIGS. 5 and 6, each of the storage units 10 includes a positive electrode and a negative electrode (not shown). The electrodes of each storage units 10 are electrically connected to the control printed circuit board 20 by the connecting module 30. The connecting module 30 includes two metal pieces 31 corresponding to each storage unit 10. The connecting module 30 further includes a spacer plate 32. The spacer plate 32 define a slit 321 corresponding to each metal piece 31 to pass the metal pieces 31 therethrough. The two ends of each metal piece 31 separately disposed on both sides of the spacer plate 32 are soldered to one of electrodes and the control printed circuit board 20 respectively. The spacer plate 32 can keep the metal pieces 31 isolated from each other and also possible to keep the storage units 10 and the control printed circuit board 20 from being isolated from each other, maintain the metal pieces 31 extend along a horizontal direction and not easy to bend due to an external force. When the metal pieces 31 are soldered to the storage units 10 and the control printed circuit board 20, or when the whole of which is assembled into the outer case 40, the relative positions of the three can be maintained stable by the spacer plate 32, thus the deformation of the metal pieces 31 and the erroneous lap between the metal sheet 31 and other conductors can be prevented. In the present embodiment, the power bank 100 includes two storage units 10, the metal pieces 31 according to the storage unit 10 placed in the bottom are passed through the spacer plate 32 and are soldered on the bottom surface of the control printed circuit board 20, the metal piece 31 according to the storage unit 10 placed in the top are passed through the spacer plate 32 and are soldered on the top surface of the control printed circuit board 20.

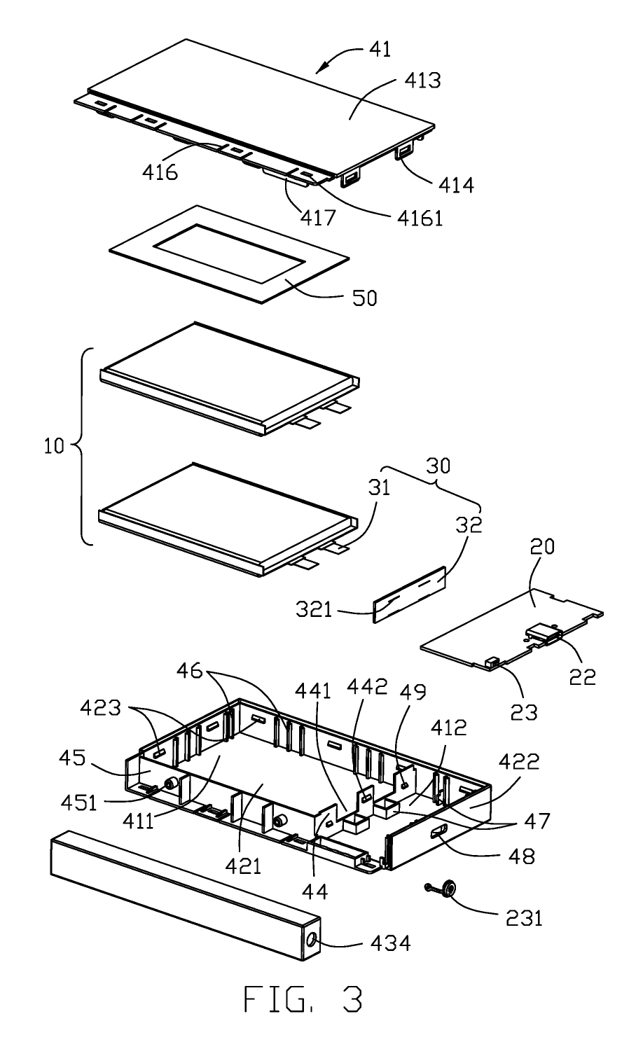

Referring to FIGS. 3 to 6, the control printed circuit board 20 is used for controlling the charging and discharging of the storage units 10. The control printed circuit board 20 is of rectangular plate. The control printed circuit board 20 defines an electrical connector 22 having an outward plug interface for charging and discharging on a side edge thereof, and a switch 23.

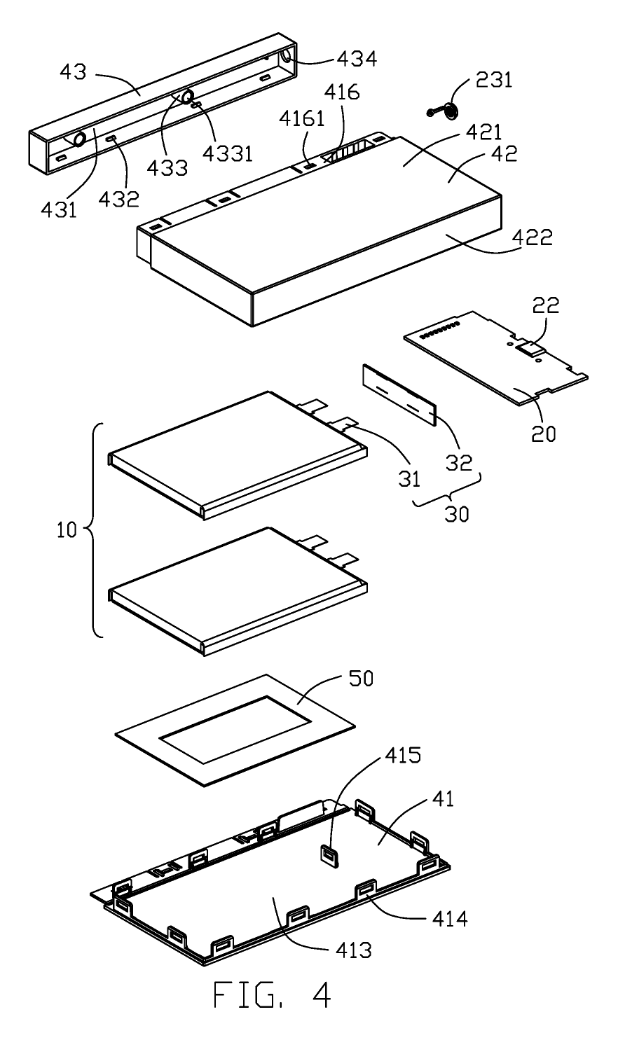

Referring to FIGS. 3 to 4, the outer case 40 includes a first case 41, a second case 42 and a third case 43, which engaged with each other by snap way. The first case 41 and the second case 42 are engaged with each other along a vertical direction to form a first containment cavity 411 and a second containment cavity 412 for respectively accommodating the storage unit 10 and the control printed circuit board 20. The first case 41 includes a top cover 413. The second case 42 includes a bottom wall 421 and a plurality of sidewalls 422 upwardly and vertically extending from the sides edges of the bottom wall 421. The second case 42 defines a fixing portion 44 for fixing the spacer plate 32. The second case 42 defines a first baffle 45 on a side of the first containment cavity 411 to define a side wall of the first containment cavity 411. The first baffle 45, the fixing portion 44 and the sidewalls 422 of the second case 42 collectively enclose the first containment cavity 411. The first case 41 defines a second baffle 417 downwardly and vertically extending from a bottom sidewall of the top cover 413. When the first case 41 engages with the second case 42, the second baffle 417, the fixing portion 44 and the sidewalls 422 collectively enclose the second containment cavity 412. The first containment cavity 411 and the second containment cavity 412 are separated from each other by the fixing portion 44. The fixing portion 44 is provided with two “U” type fixing holes 441 having an opening, to allow the metal pieces 31 near the same side to pass therethrough, thus the metal pieces 31 are electrically connected with the storage units 10 located in the first containment cavity 411 and the control printed circuit board 20 located in the second containment cavity 412 respectively. The second case 42 defines a plurality of ribs 46 projecting into the first and the second containment cavity 411, 412 on the side walls 422 and the first baffle 45, for stable fixing the storage units 10 and the control printed circuit board 20, thus the storage units 10 and the control printed circuit board 20 are prevented from shaking in the in the first and second containment cavity 411, 412 along the horizontal and a front-to-rear directions. The second case 42 spaced defines a plurality of inwardly extending disposing positioning portion 47 on the bottom wall 421 and the sidewalls 422, on which the control printed circuit board 20 placed, to adjust the height of the control circuit board 20 relative to the bottom wall 421 by the height of the positioning portion 47, thereby preventing the bending of the metal pieces 31. The fixing portion 44 is provided with a plurality of stopper portions 49 into the second containment cavity 412. The edges of the control printed circuit board 20 are disposed above the positioning portions 47 and under the stopper portions 49. The outer case 40 defines a through hole 48 corresponding to the plug interface of the electrical connector 22 near the control printed circuit board 20, thus the plug interface of the electrical connector 22 is leaked through the through hole 48 to the outside of the outer case 40.

The first case 41 defines a plurality of first snap portions 414 and a plurality of the second snap portions 415 downwardly and vertically extending from the side edges and the central region respectively. Each of the first snap portions 414 and the second snap portions 415 defines a rectangular snap hole 4141. The fixing portion 44 is provided with a first catch 442 corresponding to the first snap portions 414 near a top portion between the two fixing holes 441. The sidewalls 422 of the second case 42 and an inner side wall of the baffle 45 are provided with a plurality of second catches 423 near the top end thereof corresponding to the first snap portions 414. The first and second catches 441, 423 are caught in the snap holes 4141 of the corresponding first and second snap portions 414, 415, to engage the first case 41 to the second case 42.

The third case 43 is of a rectangular box having a single side opening 431. The third case 43 defines a plurality of third catches 432 on the inside walls near the side opening 431. The third case 43 defines a plurality of positioning columns 433 vertically extending from an inside wall opposite to the side opening 431. Each of the positioning columns 433 defines a receiving hole 4331 in a central portion thereof. The top cover 413 of the first case 41 and the bottom wall 421 of the second case 42 respectively interval defines a plurality of third snap portions 416 corresponding to the third catches 432. Each of the third snap portions 416 defines a snap hole 4161. An outside wall of the first baffle 45 outwardly defines a plurality of projections 451 corresponding to the positioning columns 433. The third catches 432 are caught in the snap hole 4161 of the third snap portion 416 of the first and second case 41,42, simultaneously, the projection 451 are inserted into the corresponding receiving hole 4331, thus he first case 41, the second case 42, and the third case 43 are assembled.

Referring to FIGS. 1, 3 and 4, the switch 23 includes a button 231. A side wall of the third case 43 defines an opening 434 for accommodating the button 231, thus the button 231 is leaked outside the outer case 40 through the opening 434. The user can control the storage unit 10 to charge or discharge through the electrical connector 22 by operating the button 231.

Referring to FIGS. 3 and 6, the top of the storage unit 10 is provided with an adjusting member 50. The adjusting member 50 is disposed between the storage units 10 and the top cover 413 of the outer case 40, to prevent the storage units 10 from shaking in the outer case along the vertical direction. In the present embodiment, the adjusting member 50 is a double-sided adhesive having a certain thickness and elasticity. In other embodiment, the adjusting member 50 may also have other structures with a certain fixed force that can provide thickness and elasticity.

Referring to FIGS. 3 and 6, the number of the storage units 10 of the utility model can be adjusted according to the setting of the electric quantity of the product. The power bank 100 of the utility model has a single electrical connector 22 as a charging and discharging port of the mobile power source, which is convenient for the user's identification and is simple to operate. The utility model has the advantages of simple structure, convenient, economical, and simple appearance.

What is claimed is:

1. A power bank comprising:
a storage unit;
a control printed circuit board defining an electrical connector having a plug interface exposed to the power bank for charging and discharging;
a connecting module electrically connected between the storage unit and the control printed circuit board;
an outer case having a first containment cavity and a second containment cavity to contain the storage unit and the control printed circuit board, respectively;
wherein
the connecting module includes a spacer plate separating the first containment cavity from the second containment cavity and a plurality of metal pieces, the spacer plate has a slit for allowing each of the metal pieces to pass through, and two opposite ends of each metal piece are electrically connected to the storage unit and the control printed circuit board, respectively.

2. The power bank as claimed in claim 1, wherein the outer case includes a first case and a second case engaged with the first case for forming the first and second containment cavity, the first case includes a top cover, the second case includes a bottom wall and a plurality of sidewalls upwardly and vertically extending from the bottom wall to snap with the first case, and the spacer plate is vertically formed on the bottom wall of the second case.

3. The power bank as claimed in claim 2, wherein the bottom wall of the second case is provided with a fixing portion for fixing the spacer plate, the fixing portion is provided with two U-shaped fixing holes having openings to allow the metal pieces at the same side to pass through so that the metal pieces is electrically connected with the storage unit and the control printed circuit board located, respectively.

4. The power bank as claimed in claim 3, wherein the second case defines a vertical baffle on the bottom wall, and the baffle, the sidewalls of the second case, and the spacer plate collectively enclose the first containment cavity.

5. The power bank as claimed in claim 4, wherein the outer case further includes a third case, the third case has a single side opening, and when the first case and the second case engage with each other, two side edges of the engaged first and second cases are inserted into the third housing through the single side opening and are fixedly enclosed therein.

6. The power bank as claimed in claim 5, wherein the first case defines a plurality of first snap portions on side edges of a top cover thereof, and the second case defines a plurality of first catches to snap with corresponding first snap portions.

7. The power bank as claimed in claim 6, wherein the first case and the second case define a plurality of second snap portions on the side edges enclosed by the third case, and the third case defines a plurality of second catches on inside walls thereof to snap with corresponding second snap portions for engaging the third case to the first and second cases.

8. The power bank as claimed in claim 2, wherein the second case defines a plurality of ribs on the side wall and the baffle projects into the first and second containment cavities.

9. The power bank as claimed in claim 3, wherein the bottom wall of the second containment cavity protrudes a plurality of positioning portions, and the control printed circuit board is placed on the positioning portions.

10. The power bank as claimed in claim 9, wherein the fixing portion is provided with a plurality of stopper portions, and the control printed circuit board is disposed above the positioning portions and under the stopper portions.

11. A power bank comprising:
a storage unit;
a control printed circuit board equipped with a single electrical connector having a plug interface accessible from an exterior for charging and discharging, and further with a switch operable from said exterior to decide either charging or discharging;
a connecting module electrically connected between the storage unit and the control printed circuit board;
an outer case to enclose the storage, the control printed circuit board and the connecting module; wherein
both said electrical connector and said switch are located on a same side of said control printed circuit board and said outer case has corresponding openings to expose both said electrical connector and said switch to the exterior, respectively.

12. The power bank as claimed in claim 11, wherein said switch is locate around a corner of the control printed circuit board while the electrical connector is located around a centerline of the control printed circuit board.

13. The power bank as claimed in claim 11, wherein the outer case forms two containments along a front-to-back direction to respectively receive the control printed circuit board and said storage unit.

14. The power bank as claimed in claim 13, wherein said plug interface is exposed to the exterior along said front-to-back direction.

15. The power bank as claimed in claim 13, wherein the storage unit is further associated with an adjusting member located between a top cover of the outer case and the storage unit as a buffer in a vertical direction perpendicular to said front-to-back direction.

16. The power bank as claimed in claim 11, wherein said outer case includes a first case, a second case assembled to each other in a vertical direction, and further a third case assembled to both said first case and said second case in a transverse direction perpendicular to said vertical direction.

17. The power bank as claimed in claim 16, wherein said plug interface is exposed to the exterior in a front-to-back direction perpendicular to both said vertical direction and said transverse direction.

18. The power bank as claimed in claim 16, wherein the opening through which the switch is accessible from the exterior, is located in the third case.
